(19) United States
(12) Patent Application Publication
(10) Pub. No.: US 2012/0159388 A1
(43) Pub. Date: Jun. 21, 2012

(54) SYSTEM AND METHOD FOR IN-CONTEXT APPLICATIONS

(75) Inventors: Olivier Chalouhi, Redwood City, CA (US); Keith Ohlfs, Redwood City, CA (US)

(73) Assignee: FANHATTAN, L.L.C., SAN MATEO, CA (US)

(21) Appl. No.: 12/973,690

(22) Filed: Dec. 20, 2010

(51) Int. Cl. G06F 3/048

(52) U.S. Cl. 715/810

(57) ABSTRACT

In a method and system for providing in-context applications, a context is selected by a user. Context-specific metadata is retrieved from a context data structure. At least one application identified in the context data structure is loaded for the context. A user interface that includes at least one selectable user interface element is rendered for the context. The selectable user interface element is used to select the at least one loaded application. Based on a determination that a selectable user interface element has been selected, the context-specific metadata is passed to the selected application for use in retrieving context-related data. The context-related data is received via the application.

### TECHNICAL FIELD

Aspects of the present disclosure relate generally to media content, and more specifically, to a system and method for in-context applications.

### BACKGROUND

Software applications generally are designed to aid a user in performing an activity or accomplishing a task. To perform the activity or accomplish the task, applications typically guide a user through a process from an initial state to an end state, with the various states representing steps of the process. Each state may involve one or more of data processing, user input, and data output.

As smart devices and information appliances have proliferated, software applications (“apps”) have increased in quantity and popularity. Currently, many device platforms offer their own “application stores” in which users may download apps to execute on a device. These apps may be written by the platform developer or third party developers. Many content providers have developed platform-specific apps that allow a user to natively access content offered by the providers. Generally, each app directs a user to an initial user interface screen, such as a home page, from which the user is able to navigate and browse among offered content. To access a particular piece of content, a user may be required to take one or more actions or steps to reach the piece of content.

### BRIEF DESCRIPTION OF DRAWINGS

The present invention is illustrated by way of example, and not by way of limitation, in the figures of the accompanying drawings.

FIG. 1 is a block diagram illustrating a network system having an architecture configured for exchanging data over a network, according to an example embodiment.

FIG. 2 is a block diagram showing modules of a client application, executing on a client machine or network device, according to an example embodiment.

FIG. 3 is a diagram illustrating context lists maintained by a client application and their interactions with content sources, according to an example embodiment.

FIG. 4 is a diagram of a user interface that provides in-context applications, according to an example embodiment.

FIG. 5 is a flowchart that illustrates an example method of providing in-context applications.

FIG. 6 shows a diagrammatic representation of a machine in the example form of a computer system.

### DETAILED DESCRIPTION

Although the disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

In various example embodiments, a system and method for providing in-context applications is disclosed. A context may have at least one content item and may be selected by a user may be identified. Context-specific metadata may be retrieved from a context data structure. At least one application identified in the context data structure may be loaded for the context. A user interface that includes at least one selectable user interface element may be rendered for the context. The selectable user interface element may be used to select the at least one loaded application. Based on a determination that a selectable user interface element has been selected, the context-specific metadata is passed to the selected application for use in retrieving a content item included in the context. The content item may be received via the application.

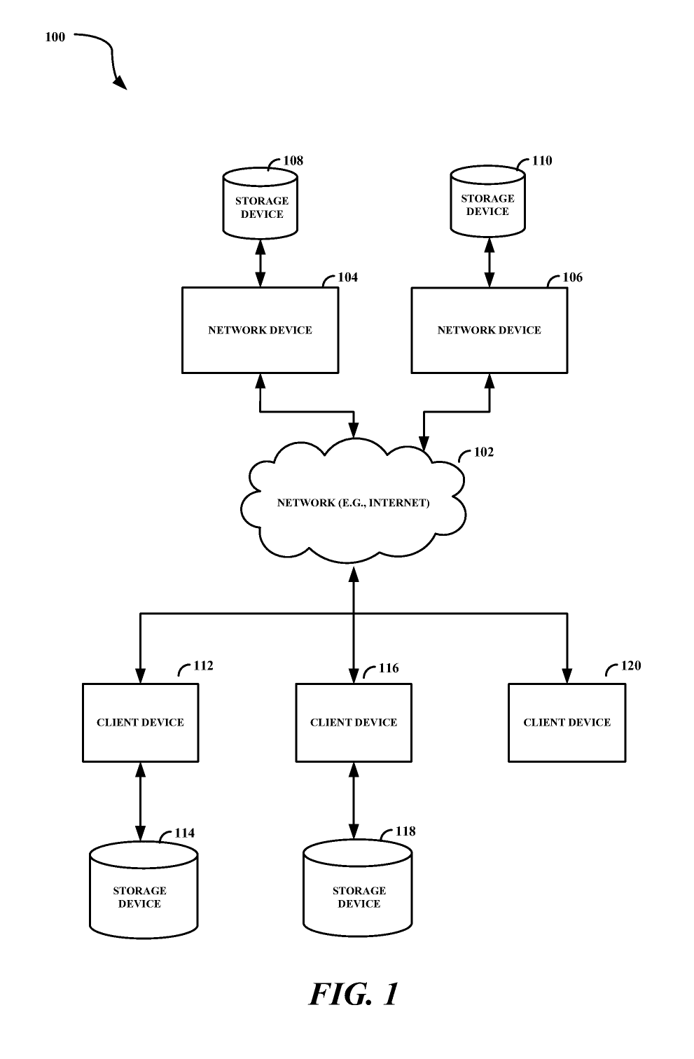

FIG. 1 is a block diagram illustrating an example network system 100 connecting one or more client devices 112, 116, 120 to one or more network devices 104, 106 via a network 102. The one more client devices 112, 116, 120 may include Internet- or network-enabled devices, such as consumer electronics devices (e.g., televisions, DVD players, Blu-Ray® players, set-top boxes, portable audio/video players, gaming consoles) and computing devices (e.g., personal computer, laptop, tablet computer, smart phone, mobile device). The type of client devices is not intended to be limiting, and the foregoing devices listed are merely examples. The client devices 112, 116, 120 may have remote, attached, or internal storage devices 114, 118. One or more of the client devices 112, 116, 120 may have installed thereon and may execute a client application (not shown) that enables the client device to serve as a local media server instance. The client application may search for and discover media content (e.g., audio, video, images) stored on the device as well as media content stored on other networked client devices having the client application installed thereon. The client application may aggregate the discovered media content, such that a user may access local content stored on any client device having the client application installed thereon. The discovered media content may be stored in an aggregated data file, which may be stored on the client device. The local content may be indexed by the client device in which the content resides. The client application also may present a variety of remote sources to the user from which the user is able to download, stream, or otherwise access a particular media content item. For example, the client application may present to the user all streaming, rental, and purchase options for the media content item to the extent they exist and are available for access.

In an example embodiment, content-related data also may be stored in a database associated with the client application. The database may contain a record for each discovered content item. The record may include known or discovered metadata about the content item. As additional metadata is obtained for the content item, the corresponding database record for the content item may be updated to include the additional metadata.

One or more network devices 104, 106 may be communicatively connected to the client devices 112, 116, 120 via network 102. The network devices 104, 106 may be servers storing media content or metadata relating to media content available to be accessed by the client devices 112, 116, 120. In an example embodiment, network devices 104, 106 may include proprietary servers related to the client application as well as third party servers hosting free or subscription-based content. Additional third-party servers may include servers operating as content metadata repositories. For example, in the context of movies, third-party servers may be servers associated with the themoviedb.org and other third-party aggregators that store and deliver movie metadata in response to user requests. The network devices 104, 106 may include attached storage devices or may interface with databases or other storage devices 108, 110. For illustrative purposes only, the network devices 104, 106 have been shown as a single device in FIG. 1, although it is contemplated that the network devices 104, 106 may include one or more web servers, application servers, database servers, and so forth, operating in conjunction to store and deliver content via network 102.

The proprietary servers may store metadata related to media content and data that facilitates identification of media content across multiple content servers. For example, the proprietary servers may store identifiers for media content that are used to interface with third party servers that store or host the media content. The proprietary servers further may include one or more modules capable of interfacing with third-party content servers and metadata repositories.

The client application may serve as a platform for supporting one or more applications that interface with the client application. In an example embodiment, the applications may interface with the client application via an application plug-in framework. Each application that plugs into the client application may permit a user to access content or content-related information from a corresponding local or remote source. The applications may plug in to the client application at various contexts. Each context may represent a content item, a list of content items, a category of context items, or one or more widgets or applications, among other things. Each context may have an associated user interface that may present one or more plugged-in applications to the user for selection. Selection of a plug-in application may result in the application communicating with a content source to transmit a request for content and to retrieve content in response to the request.

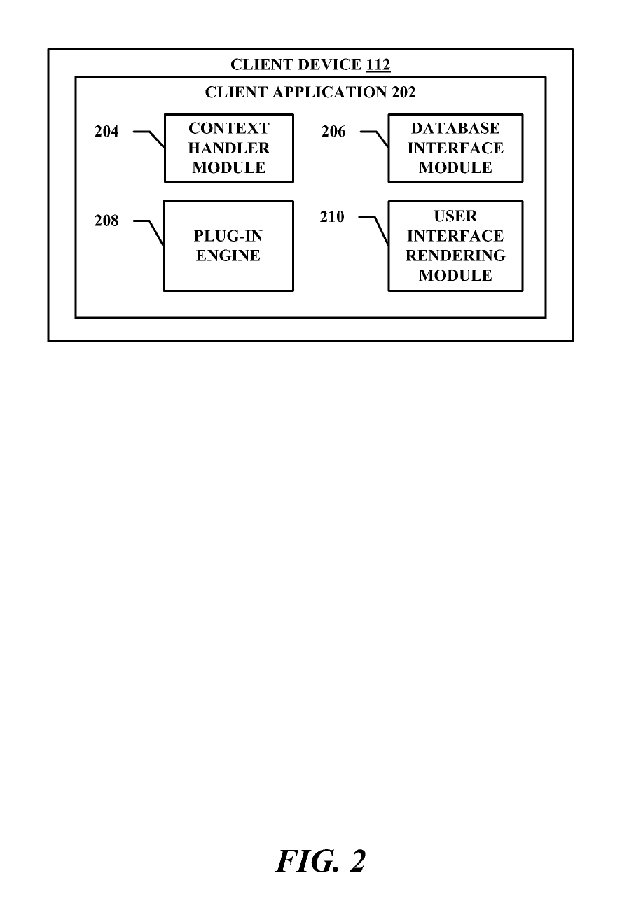

FIG. 2 is a block diagram showing certain modules of the client application, executing on a client machine or network device, according to an example embodiment. Although the modules are shown in FIG. 2 as being part of a client device, it is contemplated that the modules may be implemented on a network device, such as a server. In an example embodiment, one or more processors of the client or network device may execute or implement the modules.

The client application 202 includes modules, such as a context handler module 204, a database interface module 206, a plug-in engine 208, and a user interface rendering module 210, to perform operations of an example embodiment.

A context handler module 204 may be configured to identify and register one or more contexts to provide to the user in response to user interaction with the client application 202. When the client application 202 launches, the context handler module 204 may access a list of contexts maintained by the client application, for example, in a database. The context handler module 204 may register all of the contexts or selected contexts included in the list of contexts.

As the user traverses through one or more presented web pages or user interfaces, the context handler module 204 may track user interaction with the presented web pages or user interfaces. User interaction may include the selection of user-selectable elements presented on a web page or user interface and the movement of a user input device indicator (e.g., cursor, arrow, selection indicator) on the web page or user interface. The context handler module 204 may identify the one or more contexts related to the user interaction by accessing and retrieving a context data structure (e.g., a list, a table, a record) associated with a particular user interface being displayed or selected for display. Contexts also may be identified based on user input, such as the selection of a user-selectable element.

The context handler module 204 may retrieve the relevant context and switch contexts in response to the traversals. For example, the client application may present an initial home screen or web page to a user. The home screen may set forth various categories of content (e.g., music, movies, television shows, merchandise) that the user may browse through or search among. The home screen also may enable a user to enter search terms to filter through the content. As the user navigates or searches among the content, each displayed screen (e.g., web page, user interface) may be considered as a context. Thus, a page displaying movies falling within the comedy genre may be considered a context. A page displaying a specific movie or television show episode may be considered to be a context as well. Contexts also may include pages or user interfaces that display selectable widgets or applications without any content. The client application 202 may store a context data structure (e.g., in a database) for each context. The context data structure may include content identifying information (e.g., name, identifier) and content metadata for the context. Thus, a page displaying a specific movie may have an associated context data structure storing the name or identifier of the movie and metadata related to the movie (e.g., cover art, screenshots, title, synopsis, cast members, release date).

A database interface module 206 may interface with local and remote sources to retrieve relevant metadata and content for a particular context. The client application may be associated with one or more local databases in which may be stored content metadata, actual content items, and context data structures. The database interface module 206 also may interface with remote content providers to retrieve content and metadata resources. The database interface module 206 may communicate with the context handler module 204 such that when the context handler module 204 identifies a context to be provided, the context handler module 204 may issue a request to the database interface module 206 to access a database and retrieve data and metadata from the appropriate context data structure.

A plug-in engine 208 may operate in communication with the context handler module 204 and the database interface module 206 to register and load apps for a particular context identified by the context handler module 204 and using metadata retrieved by the database interface module 206. The client application 202 may offer a set of services which may be used by various apps to interface with the client application 202. In an example embodiment, the client application 202 may use a set of open Application Programming Interfaces (APIs) or web services that enable apps to communicate and exchange data with the client application 202. The apps themselves may use APIs or web services to communicate and exchange data with a local or remote content source.

A context may include one or more apps that access content or data related to the context from content sources (e.g., local sources, remote sources). In addition to storing identifying information and metadata for a context, a context data structure may store a list of relevant or applicable apps for the context. In an example embodiment, when the client application 202 launches, the plug-in engine 208 may register the apps associated with each registered context. In another example embodiment, when a particular context is selected, the plug-in engine 208 may identify and load the registered apps associated with the context. The plug-in engine 208 may communicate with the database interface module 206 to retrieve a content identifier corresponding to a content item included in the particular context. The content identifier may enable an app loaded by the plug-in engine 208 for the particular context to access a content item from a content source associated with the app. The plug-in engine 208 also may receive metadata related to the content items included in the context. The metadata may be passed to the plug-in engine 208 as parameters to be used by the context apps when retrieving content items or content data from content sources.

In an example embodiment, a user may interact with the client application 202 and navigate to a web page or user interface related to a particular movie. The web page or user interface for the movie may be considered as a context. The context may display information related to the movie, such as the title of the movie, a graphical background consisting of images from the movie, a plot synopsis of the movie, and so forth. The context also may display one or more user-selectable apps. The apps may be initialized and loaded as plug-ins to the client application 202 by the plug-in engine 208. Each app may be associated with a content source. For example, a Netflix® app may permit a user to access the user's Netflix® account to retrieve or stream content. A Rotten Tomatoes® app may permit a user to access the website RottenTomatoes.com to retrieve metadata (e.g., reviews, ratings, summaries, cast listing) related to the movie. A content identifier for the movie may be passed to each app to direct the app to the content item without having to navigate within the app to find the content item. In an example embodiment, each app may use a different content identifier for the movie. The context data structure may store each app's content identifier. Metadata related to the movie also may be passed to each app as one or more parameters that may be used to direct each app to the appropriate content item within the app. Thus, in an example embodiment in which a user attempts to use an in-context Netflix® app to access a movie displayed in a context, selection of the Netflix® in-context app displayed in the context may result in the Netflix® app retrieving the movie and providing the movie to the user via one or more distribution channels (e.g., streaming, download). The user is not forced to navigate from the Netflix® home page to find the movie and then select a distribution channel for retrieving the movie. The retrieval of the movie is performed seamlessly via the in-context app.

The switching of contexts from a first context to a second context may prompt the plug-in engine 208 to access the context data structure associated with the second context to identify and load apps associated with the second context.

A user interface rendering module 210 may be configured to render a user interface for each context. The user interface rendering module 210 may use certain metadata to render the context-specific user interface. For example, if the context is a specific movie, the user interface rendering module 210 may use art and images related to the movie to render the user interface. In an example embodiment, the user interface rendering module 210 may use an image or collage of images to serve as the background image for the user interface. The user interface rendering module 210 also may receive instructions from the client application 202 or one of the other modules 204, 206, 208 regarding the allocation of space within the user interface for certain user interface elements. For example, the context handler module 208 may inform the user interface rendering module 210 to allocate user interface real estate for user-selectable elements corresponding to the apps that are loaded for the context. The user interface rendering module 210 may receive the metadata and instructions and render a user interface for the context. When a switch in contexts is detected by or provided to the user interface rendering module 210, the user interface rendering module 210 may generate a new user interface corresponding to the new context.

The client application 202 and its corresponding modules 204, 206, 208, 210 may thus implement a content system in which a user is permitted to directly access content and content metadata through one or more apps that correspond to content sources. The consolidation of apps available for a particular context saves the user from having to access each app individually, with the user uncertain of whether that particular app or content source provides the content item. Further, the use of contexts enables the user to quickly and directly access the content item within each app such that the user is freed from having to navigate within each app to identify the particular content item.

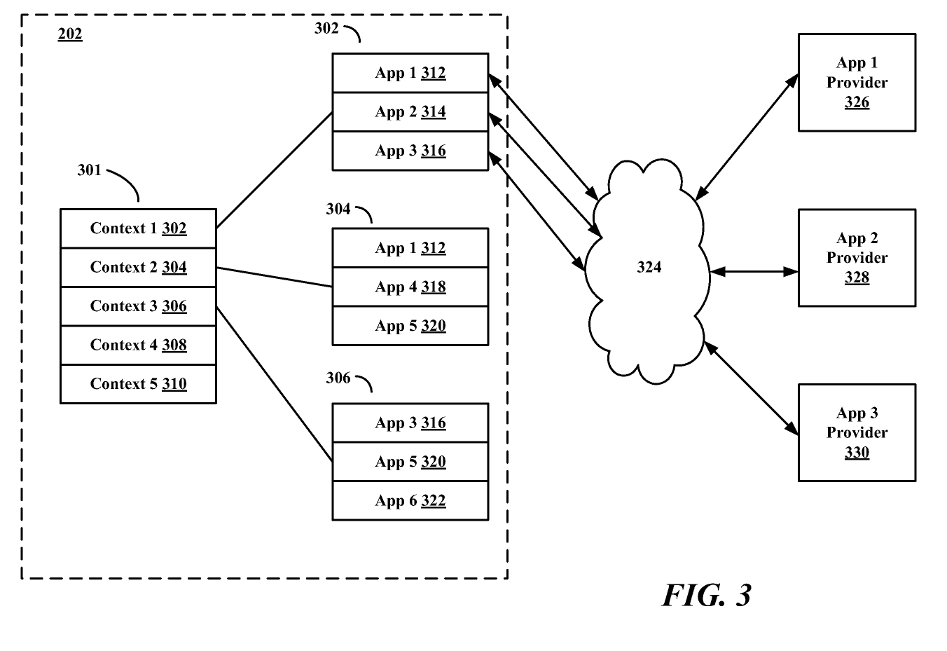

FIG. 3 is a diagram illustrating context lists maintained by a client application and their interactions with content sources, according to an example embodiment. Referring to FIG. 3, the client application 202 may maintain a list of contexts in a context data structure 301. The context data structure 301 may be a list, a table, an array, or any other structure capable of storing multiple entries. The context data structure 301 illustrated in FIG. 3 may store five contexts—Context 1 302, Context 2 304, Context 3 306, Context 4 308, and Context 5 310. Each context may pertain to an individual content item, a list of content items, a content item category or list of content item categories, a sub-list of a list, or one or more widgets or applications unrelated to any particular piece of content, among other things. For example, Context 1 302 may represent a list of comedy movies. In an example embodiment, Context 2 304 may represent a particular television show, and Context 3 306 may represent episodes of the television show from a particular season.

Each context may have associated therewith a list of applications that represent content sources having or storing content related to the context. For example, in FIG. 3, Context 1 302 is illustrated as having three applications—App 1 312, App 2 314, and App 3 316—associated with it. The apps associated with a particular context also may be associated with other contexts, as shown in FIG. 3 by Context 1 302 and Context 2 304 both loading App 1 312. It should be appreciated that other data and metadata may be stored and associated with each context. The plug-in engine 208 of the embodiment of FIG. 2 may register the applications associated with each context. In an example embodiment, the activation or selection of Context 1 302 may include the loading of the three apps by plug-in engine 208. The user interface rendering module 210 may render a user interface for each context, and each user interface may include real estate and user-selectable elements for the apps associated with the context. Upon selection of an app, the app may initiate communication with a corresponding content provider, located either locally or remotely via network 324. For example, in the example embodiment of FIG. 3, the selection of App 1 312 may result in App 1 312 initiating communication and exchanging data with App 1 Provider 326. In an example embodiment, App 1 312 may be a streaming video app that enables a user viewing the context to stream content identified on the context user interface from App 1 Provider 326. In other example embodiments, App 1 312 may be an app that facilitates the purchase of merchandise related to the content displayed in Context 1 302 from App 1 Provider 326 or an app that enables a user to retrieve additional information about the content displayed in Context 1 302.

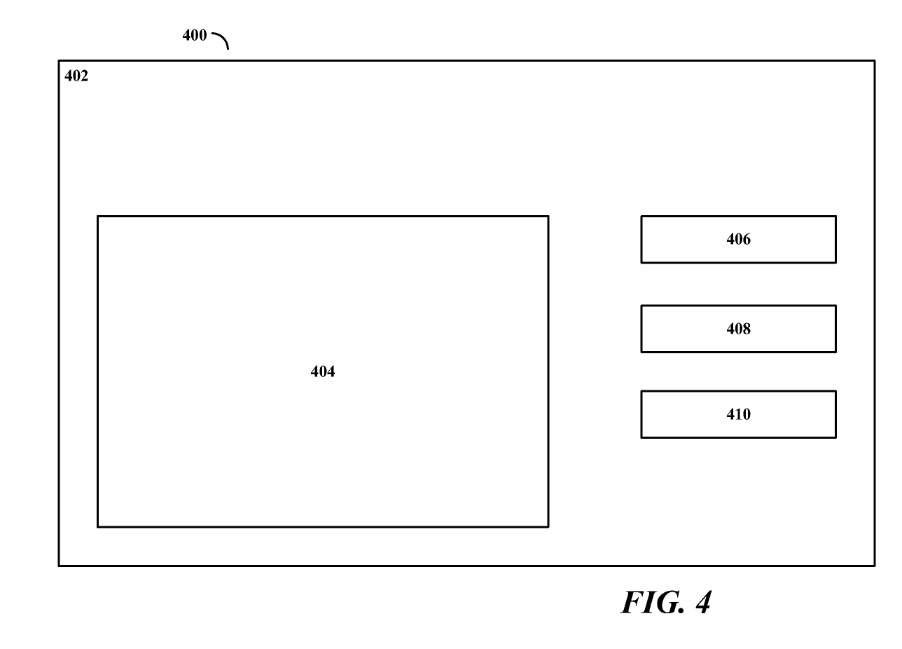

FIG. 4 is a diagram of a user interface that provides in-context applications, according to an example embodiment. Referring to FIG. 4, a user interface 400 of client application 202 displaying a context is illustrated. The user interface 400 may include a background portion 402 in which art, images, or other metadata related to the context is displayed. For example, if the context is a specific content item, art related to the specific content item may be displayed as a background image in background section 402. If the context is a list of content items, visual imagery or text associated with the list of content items or one or more of the content items in the list may be displayed in the background section 402.

User interface 400 may include a dynamically updatable descriptive section 404 in which various information related to the context may be displayed. The information may be text, audio, or visual information. For example, if the context concerns a specific content item, the information displayed may be text (e.g., a review, a plot synopsis, a listing of the cast of the content item) related to the content item. The user interface rendering module 210 of the example embodiment of FIG. 2 may update or refresh the content displayed in the description section 404 on a periodic basis.

User interface 400 may include one or more user-selectable elements 406, 408, 410. User-selectable elements may be shortcuts or icons linked to loaded plug-in apps associated with the context. Selection of one or more of the user-selectable elements 406, 408, 410 may execute an app that communicates with a content source to retrieve or stream content or metadata to the client application 202. The apps associated with the content may interface with the client application 202 via a client application service interface or open API. The client application 202 may serve as a platform for the various apps associated with the contexts such that the apps may be written to execute natively within the client application 202. The apps may use context-specific information to retrieve context-specific content from the content providers associated with the apps. In an example embodiment, context-specific information may be passed to the apps as parameters that are used to access context-specific content at the content provider, thereby eliminating the need to interface with the client provider and search for the particular context-specific content. Retrieved content may be displayed in the user interface, such as, for example, in the descriptive portion 404 of the user interface 400.

The foregoing example embodiment of FIG. 4 is not intended to be limiting and is but one possible layout of a user interface. One skilled in the art will appreciate that other layouts and configurations may be employed when designing and rendering a user interface for use with the client application 202.

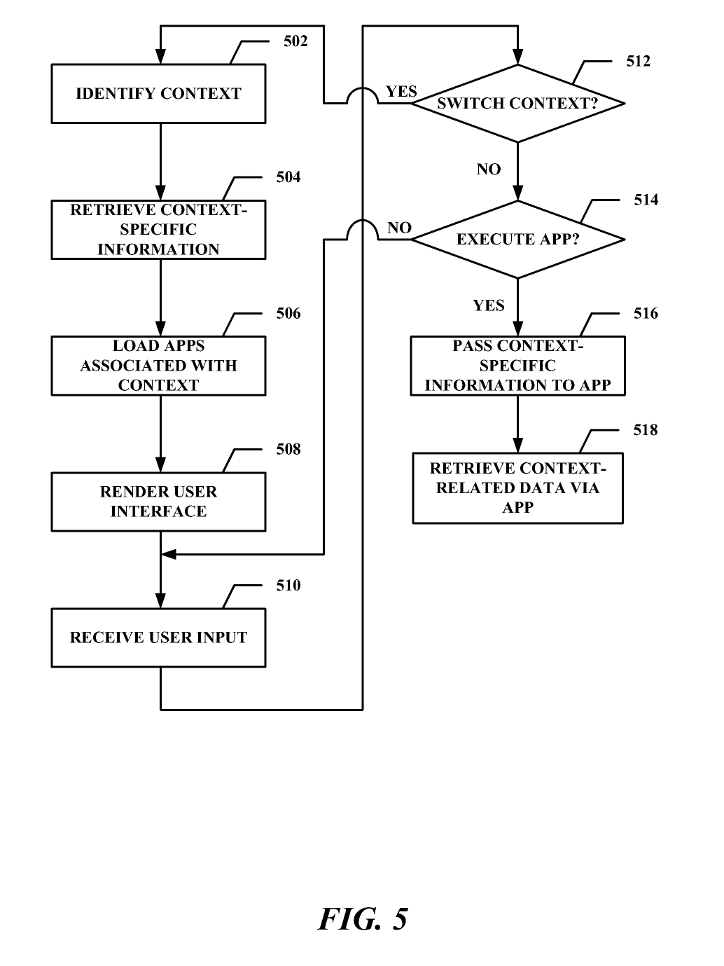

FIG. 5 is a flowchart that illustrates an example method of providing in-context applications. At operation 502, a client application executing on a computing device may receive a user selection of a context. A context may be a display screen, user interface, or web page that contains one or more content items, one or more lists of content items, or one or more widget or applications unrelated to content, among other things. The client application may present various types and categories of content to a user. The user may browse and search among the content using a user input device. A selection of a category of content, an individual content item, or a person associated with a content item(s) (e.g., an actor, an artist, a cast member), among other things, may result in the selection and display of a context.

At operation 504, in response to the selection of a context, the client application may access context records, files, or data structures (collectively, “context data structures”) that store the various contexts supported or maintained by the client application. When the appropriate context data structure is identified, metadata, content identifiers, and associated app identifiers stored in the context data structure may be retrieved.

At operation 506, the app identifiers stored in the context data structure may be used to register and load plug-in apps for the selected context. The plug-in apps may interface with the context via one or more service handlers or open APIs provided by the client application. The plug-in apps may be associated and in communication with one or more content sources from which content and/or metadata may be retrieved.

At operation 508, the client application may render a user interface for the selected context using the retrieved metadata. The user interface may display information and images related to the content items associated with the context. Additionally, the user interface may include one or more user-selectable elements, including elements enabling execution of the apps associated with the context.

At operation 510, the client application may monitor and detect user input submitted via the rendered user interface. For example, the client application may detect that the user has selected a user-selectable element using a user input device. Based on the user input, the client application may perform a corresponding action.

At operation 512, based on a determination that the user input is a context switch, the client application may return to operation 502 to identify the next context to be displayed. A context switch may indicate that the user has elected to traverse displayed contexts for reasons such as to find additional or different content.

If it is determined that the user input is not a context switch, the example method may proceed to operation 514, where a determination is made as to whether the user input is a command to execute an app associated with the context. A command to execute an app may comprise a selection of a user-selectable element associated with an app. For example, a user may select a button, icon, or other element corresponding to the app. The selection of the user-selectable app element may result in the execution of the app by the client application. If it is determined that the user input is not a command to execute an app, the example method may return to operation 510 to wait an additional user input.

Based on a determination that an app is to be executed, at operation 516, context- and content-specific information may be passed to the app. The passed information may be used by the app as parameters when the app interfaces with and issues an API call to a content source. The passed information may be used by the app to interface with the content source and directly retrieve the content item(s) identified by the passed information. For example, if the context concerns a single content item, metadata and a content identifier related to the content item may be passed to the app. The content identifier may be a proprietary identifier used by the content source to identify the content item. The metadata and content identifier may be used by the app as parameters in an API call made to the content source to retrieve the content item. In this respect, the app may directly access the content item identified by the metadata and content identifier at the content source. At operation 518, the content item and/or metadata may be retrieved from the content source by the app and returned to the client application for storage, display, or playback, among other things.

### Modules, Components and Logic

Certain embodiments are described herein as including logic or a number of components, modules, or mechanisms. A component or module is a non-transitory and tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein.

In various embodiments, a component or a module may be implemented mechanically or electronically. For example, a component or a module may comprise dedicated circuitry or logic that is permanently configured (e.g., as a special-purpose processor) to perform certain operations. A component or a module also may comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” or “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components or modules are temporarily configured (e.g., programmed), each of the components or modules need not be configured or instantiated at any one instance in time. For example, where the components or modules comprise a general-purpose processor configured using software, the general-purpose processor may be configured as respective different components at different times. Software may accordingly configure a processor, for example, to constitute a particular component or module at one instance of time and to constitute a different component or module at a different instance of time.

Components or modules can provide information to, and receive information from, other components or modules. Accordingly, the described components may be regarded as being communicatively coupled. Where multiple of such components or modules exist contemporaneously, communications may be achieved through signal transmission (e.g., over appropriate circuits and buses) that connect the components or modules. In embodiments in which multiple components or modules are configured or instantiated at different times, communications between such components or modules may be achieved, for example, through the storage and retrieval of information in memory structures to which the multiple components or modules have access. For example, one component or module may perform an operation, and store the output of that operation in a memory device to which it is communicatively coupled. A further component or module may then, at a later time, access the memory device to retrieve and process the stored output. Components or modules may also initiate communications with input or output devices, and can operate on a resource (e.g., a collection of information).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various example embodiments.

### Example Machine Architecture and Machine-Readable Medium

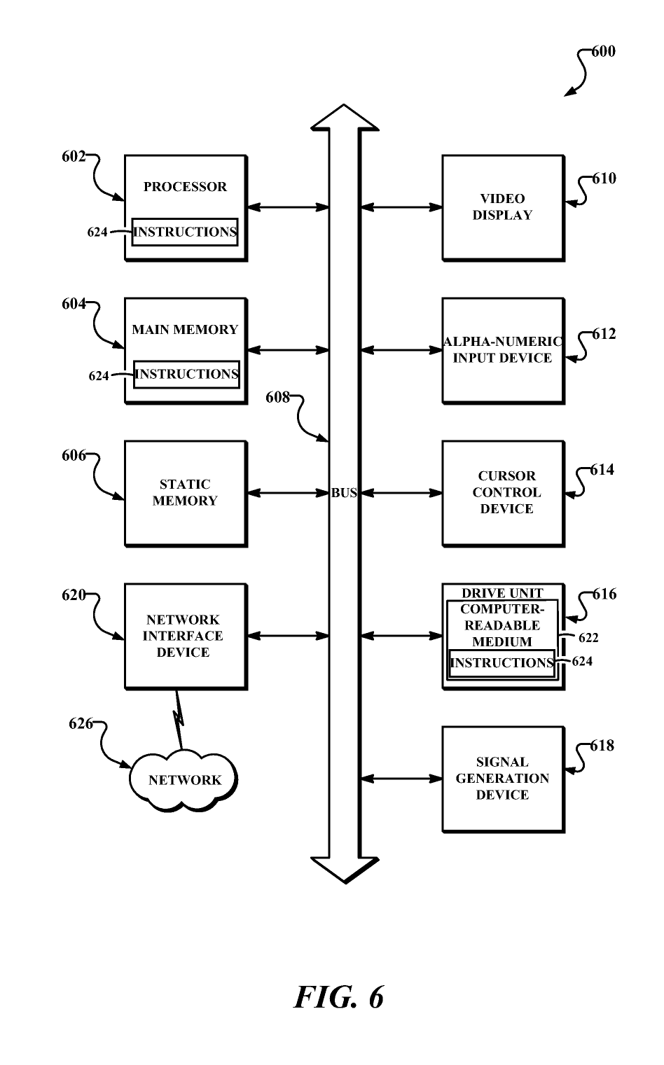

FIG. 6 is a block diagram of machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes at least one processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 624 may further be transmitted or received over a communications network 626 using a transmission medium. The software 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible medium to facilitate communication of such software.

### Example Three-Tier Software Architecture

In some embodiments, the described methods may be implemented using one a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules, or processes that govern the software as a whole. A third storage tier may be a persistent storage medium or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology, or, a variety of technologies. The example three-tier architecture, and the technologies through which it is implemented, may be realized on one or more computer systems operating, for example, as a standalone system, or organized in a server-client, peer-to-peer, distributed or so some other suitable configuration. Further, these three tiers may be distributed between more than one computer systems as various components.

### Components

Example embodiments may include the above described tiers, and processes or operations about constituting these tiers may be implemented as components. Common to many of these components is the ability to generate, use, and manipulate data. The components, and the functionality associated with each, may form part of standalone, client, server, or peer computer systems. The various components may be implemented by a computer system on an as-needed basis. These components may include software written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique.

Software for these components may further enable communicative coupling to other components (e.g., via various Application Programming interfaces (APIs)), and may be compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may form part of a first computer system that is remotely located from a second computer system containing a logic component (e.g., a logic tier). These first and second computer systems may be configured in a standalone, server-client, peer-to-peer, or some other suitable configuration. Software for the components may be written using the above described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Example embodiments may use the OSI model or TCP/IP protocol stack model for defining the protocols used by a network to transmit data. In applying these models, a system of data transmission between a server and client, or between peer computer systems may for example include five layers comprising: an application layer, a transport layer, a network layer, a data link layer, and a physical layer. In the case of software, for instantiating or configuring components, having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method, comprising:
identifying, by a processor, a context selected by a user;
retrieving, by the processor, context-specific metadata from a context data structure;
loading, by the processor, at least one application for the context, the at least one application being identified in the context data structure;
rendering a user interface for the context, the user interface including at least one selectable user interface element for selecting the at least one application;
based on a determination that the at least one selectable user interface element is selected, passing the retrieved context-specific metadata to the at least one application for use in retrieving context-related data; and
receiving the context-related data via the at least one application.

2. The computer-implemented method of claim 1, wherein the context displays at least one content item, and wherein the context-related data comprises a content item of the at least one content item.

3. The computer-implemented method of claim 1, wherein the at least one application comprises at least one plug-in application.

4. The computer-implemented method of claim 1, wherein each of the at least one application is configured to communicate with a content source.

5. The computer-implemented method of claim 1, further comprising registering the at least one application with the context.

6. The computer-implemented method of claim 1, wherein the context-specific metadata includes an identifier used by the at least one application to retrieve the context-related data.

7. The computer-implemented method of claim 6, wherein the identifier is a content identifier, and wherein the context-related data is a content item.

8. The computer-implemented method of claim 1, further comprising based on a determination that the user has selected a new context, repeating the identifying, the retrieving, the loading, the rendering, the passing, and the receiving steps for the new context.

9. The computer-implemented method of claim 1, further comprising registering the identified context.

10. A non-transitory machine-readable medium storing a set of instructions that, when executed by a processor, causes the processor to perform operations, comprising:
identifying a context selected by a user;
retrieving context-specific metadata from a context data structure;
loading at least one application for the context, the at least one application being identified in the context data structure;
rendering a user interface for the context, the user interface including at least one selectable user interface element for selecting the at least one application;
based on a determination that the at least one selectable user interface element is selected, passing the retrieved context-specific metadata to the at least one application for use in retrieving context-related data; and
receiving the context-related data via the at least one application.

11. The non-transitory machine-readable medium of claim 10, wherein the context displays at least one content item, and wherein the context-related data comprises a content item of the at least one content item.

12. The non-transitory machine-readable medium of claim 10, wherein the at least one application comprises at least one plug-in application.

13. The non-transitory machine-readable medium of claim 10, wherein each of the at least one application is configured to communicate with a content source.

14. The non-transitory machine-readable medium of claim 10, further comprising registering the at least one application with the context.

15. The non-transitory machine-readable medium of claim 10, wherein the context-specific metadata includes an identifier used by the at least one application to retrieve the context-related data.

16. The non-transitory machine-readable medium of claim 15, wherein the identifier is a content identifier, and wherein the context-related data is a content item.

17. The non-transitory machine-readable medium of claim 10, further comprising based on a determination that the user has selected a new context, repeating the identifying, the retrieving, the loading, the rendering, the passing, and the receiving steps for the new context.

18. The non-transitory machine-readable medium of claim 10, further comprising registering the identified context.

19. A system, comprising:
a processor-implemented context handler module configured to identify a context selected by a user;
a processor-implemented database interface module configured to retrieve context-specific metadata from a context data structure associated with the context identified by the processor-implemented context handler module;
a processor-implemented plug-in engine configured to load at least one application for the context, the at least one application being identified in the context data structure; and
a processor-implemented user interface rendering module configured to render a user interface for the context, the user interface including at least one selectable user interface element for selecting the at least one application,
the processor-implemented context handler module passing the retrieved context-specific metadata to the at least one application for use in retrieving context-related data based on a determination that the at least one selectable user interface element is selected.

20. The system of claim 19, wherein the context displays at least one content item, and wherein the context-related data comprises a content item of the at least one content item.

21. The system of claim 19, wherein the at least one application comprises at least one plug-in application.

22. The system of claim 19, wherein each of the at least one application is configured to communicate with a content source.

23. The system of claim 19, wherein the processor-implemented plug-in engine is further configured to register the at least one application with the context.

24. The system of claim 19, wherein the context-specific metadata includes an identifier used by the at least one application to retrieve the context-related data.

25. The system of claim 24, wherein the identifier is a content identifier, and wherein the context-related data is a content item.

26. The system of claim 19, wherein the processor-implemented context handler module is further configured to register the identified context.

27. A computer-implemented method, comprising:
generating a user interface for a context, the context associated with at least one content item;
loading at least one plug-in application in the user interface, the at least one application represented in the user interface by a corresponding at least one selectable user interface element;
responsive to a selection of a selectable user interface element, communicating with a content source over a network via the at least one application, the at least one application transmitting a content identifier and metadata associated with the at least one content item to the content source; and
receiving, by the at least one plug-in application, the at least one content item from the content source.
